(19) United States
(12) Patent Application Publication
(10) Pub. No.: US 2009/0206554 A1
(43) Pub. Date: Aug. 20, 2009

(54) STEAM TURBINE ENGINE AND METHOD OF ASSEMBLING SAME

(76) Inventors: Mark Kevin Bowen, Niskayuna, NY (US); Steven Sebastian Burdgick, Guilderland, NY (US); Jason Paul Mortzheim, Gloversville, NY (US); William Edward Adis, Scotia, NY (US); Eric Diederich Iken, Bangor, ME (US)

Correspondence Address: JOHN S. BEULICK (17851);ARMSTRONG TEASDALE LLP, ONE METROPOLITAN SQUARE, SUITE 2600, ST. LOUIS, MO, 63102-2740, US

(21) Appl. No.: 12/032,952

(22) Filed: Feb. 18, 2008

(51) Int. Cl. F01D 11/02; F16B 13/00; B23P 11/00

(52) U.S. Cl. 277/416; 411/357; 29/525.01; 415/174.2

(57) ABSTRACT

A method is provided for assembling a turbine engine. The method includes providing a retro-fit seal ring assembly that includes a plurality of unitary, arcuate ring segments that are circumferentially-spaced about a center axis of the ring assembly. Each of the plurality of ring segments includes a body and at least one integrally formed tooth that extends radially inward therefrom. The methods also includes extending at least one fastener through the body of each of the plurality of ring segments, and removably coupling each of the plurality of ring segments to an outer surface of a stationary component within the turbine engine using the at least one fastener.

### BACKGROUND OF THE INVENTION

The field of the present invention relates generally to steam turbine engines, and more particularly, to sealing systems for use with steam turbine engines.

At least some known steam turbines have a defined steam path that includes a steam inlet, a turbine, and a steam outlet. Moreover, at least some known steam turbines include stationary nozzle segments that channel a flow of steam downstream towards turbine blades extending from a rotor. At least some known stationary nozzle segments include airfoils that facilitate channeling the steam flow. Each nozzle segment, in conjunction with an associated row of rotor blades, is typically referred to as a turbine stage. Most known steam turbines include a plurality of stages.

Generally, a gap is defined between a rotor blade tip and a stationary component, such as an engine casing. Although necessary for operation, such gaps undesirably enable steam to flow around the rotor blades rather than past the rotor blades, thereby reducing the efficiency of the turbine and causing losses in the steam flow. In at least some known steam turbines, a gap defined between the rotor blade tips and the engine casing may be reduced by replacing the stationary nozzle segments for each stage. Specifically, the steam turbine is disassembled and the stationary nozzle segments for each stage are replaced with nozzle segments that include a sealing extension coupled thereto. The sealing extension is positioned between the rotor blade tip and the engine casing such that the gap is substantially sealed.

However, replacement of the stationary nozzle segments for each stage may be time consuming and may result in extended operating downtimes of the steam turbine. As a result, the costs associated with turbine repair may be increased.

### BRIEF DESCRIPTION OF THE INVENTION

In one aspect, a method is provided for assembling a turbine engine. The method includes providing a retro-fit seal ring assembly that includes a plurality of unitary, arcuate ring segments that are circumferentially-spaced about a center axis of the ring assembly. Each of the plurality of ring segments includes a body and at least one integrally formed tooth that extends radially inward therefrom. The methods also includes extending at least one fastener through the body of each of the plurality of ring segments, and removably coupling each of the plurality of ring segments to an outer surface of a stationary component within the turbine engine using the at least one fastener.

In another aspect, a seal ring assembly is provided for use in a turbine engine. The assembly includes a plurality of unitary, arcuate ring segments that are circumferentially-spaced about a center axis of the assembly. Each of the plurality of ring segments includes a body and at least one integrally formed tooth extending radially inward therefrom. At least one fastener extends through the body of each of the plurality of arcuately-shaped ring segments. Each of the plurality of ring segments is removably coupled to an outer surface of a stationary component within the turbine engine using the at least one fastener.

In a further aspect, a turbine engine is provided. The engine includes a stationary component, and a seal ring assembly that is coupled to the stationary component. The assembly includes a plurality of unitary, arcuate ring segments that are circumferentially-spaced about a center axis of the assembly. Each of the plurality of ring segments includes a body and at least one integrally formed tooth extending radially inward therefrom. At least one fastener extends through the body of each of the plurality of arcuately-shaped ring segments. Each of the plurality of ring segments is removably coupled to an outer surface of a stationary component within the turbine engine using the at least one fastener.

### BRIEF DESCRIPTION OF THE DRAWINGS

FIG. 1 is a cross-sectional schematic illustration of an exemplary steam turbine;

FIG. 2 is a cross-sectional schematic illustration of a portion of a high pressure turbine section including a seal ring assembly that may be used with the steam turbine shown in FIG. 1;

FIG. 3 is an enlarged view of a portion of the seal ring assembly shown in FIG. 2;

FIG. 4 is a cross-sectional schematic illustration of a portion of a high pressure turbine section including an alternative seal ring assembly that may be used with the steam turbine shown in FIG. 1; and

FIG. 5 is an enlarged view of a portion of the seal ring assembly shown in FIG. 4.

### DETAILED DESCRIPTION OF THE INVENTION

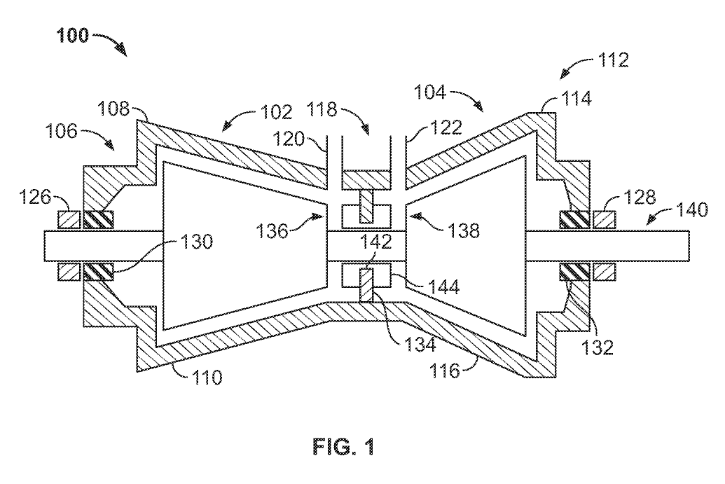

FIG. 1 is a cross-sectional schematic illustration of an exemplary opposed-flow steam turbine engine 100 including a high pressure (HP) section 102 and an intermediate pressure (IP) section 104. An HP shell, or casing, 106 is divided axially into an upper half section 108 and a lower half section 110. Similarly, an IP shell 112 is divided axially into an upper half section 114 and a lower half section 116. In the exemplary embodiment, shells 106 and 112 are inner casings. Alternatively, shells 106 and 112 may be outer casings. A central section 118 positioned between HP section 102 and IP section 104 includes a HP steam inlet 120 and an IP steam inlet 122. In the exemplary embodiment, HP section 102 and IP section 104 are arranged in a single bearing span supported by journal bearings 126 and 128. Steam seal apparatus 130 and 132 are located inboard of each journal bearing 126 and 128, respectively.

An annular section divider 134 extends radially inward from central section 118 towards a rotor shaft 140 that extends between HP section 102 and IP section 104. More specifically, divider 134 extends circumferentially around a portion of rotor shaft 140 between a first HP section inlet nozzle 136 and a first IP section inlet nozzle 138. Divider 134 is received in a channel 142 defined in a packing casing 144. More specifically, in the exemplary embodiment, channel 142 is C-shaped and extends radially into packing casing 144 and around an outer circumference of packing casing 144, such that a center opening of channel 142 faces radially outward.

Steam turbine 100, in the exemplary embodiment, also includes a plurality of turbine rotor blades, or buckets, 146 (not shown in FIG. 1) that are coupled to rotor shaft 140. Each rotor blade 146 has a blade tip 141. A stator assembly is positioned adjacent each set of turbine rotor blades 146 such that a stage 147 is formed. Each stage defines a steam flow path 148 (not shown in FIG. 1).

In the exemplary embodiment, steam turbine 100 is an opposed-flow high pressure and intermediate pressure steam turbine combination. In an alternative embodiment, steam turbine 100 may be used with any individual turbine including, but not being limited to low pressure turbines. In another alternative embodiment, steam turbine 100 may be used with steam turbine configurations that include, but are not limited to, single-flow and double-flow turbine steam turbines. In yet another alternative embodiment, steam turbine 100 may be used with a gas turbine engine.

During operation, HP steam inlet 120 receives high pressure/high temperature steam from a steam source, for example, a power boiler (not shown). The steam is channeled through HP section 102 from inlet nozzle 136 wherein work is extracted from the steam to rotate rotor shaft 140 via rotor blades 146.

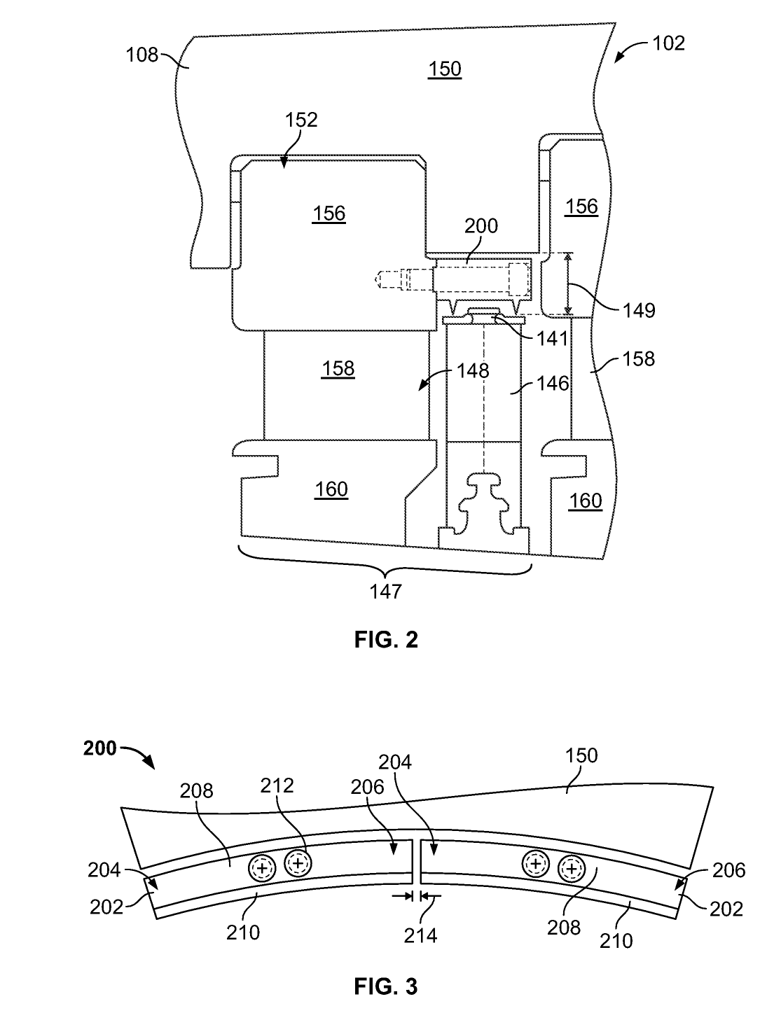

FIG. 2 is a cross-sectional schematic view of a portion of HP section 102 of steam turbine engine 100 including a seal ring assembly 200. FIG. 3 is an enlarged view of a portion of seal ring assembly 200. In the exemplary embodiment, HP section 102 is assembled by removably coupling upper half section 108 to lower half casing 110 (shown in FIG. 1). A nozzle carrier top half 150 is coupled to a radially inner surface of upper half section 108 such that carrier top half 150 extends a radially inward from casing 106. As a result, nozzle carrier top half 150 remains in a substantially fixed position with respect to turbine rotor 140. HP section 102 also includes a plurality of stationary bladed ring or bling assemblies 152 coupled therein. A nozzle carrier bottom half (not shown) is coupled to lower half section 110 and receives the nozzle and bling assemblies 152 in a manner similar to nozzle carrier top half 150. In the exemplary embodiment, bling assemblies 152 each include a radially outer portion 156, a nozzle portion 158 and a radially inner portion 160. A set of rotor blades 146 is positioned adjacent to each bling assembly 152 to form stage 147 that defines a portion of steam path 148. A gap 149 is defined between each rotor blade tip 141 and carrier top half 150.

Seal ring assembly 200 is removably coupled to the radially outer portion 156 of each bling assembly 152 in each turbine stage 147. In the exemplary embodiment, seal ring assembly 200 is substantially circular and is formed from a plurality of circumferentially-adjacent seal segments 202. Each seal segment 202 includes a first end 204, a second end 206, and a body 208 extending therebetween. Moreover, at least one tooth 210 extends radially inward from seal segment 202. Specifically, in the exemplary embodiment, each segment 202 is integrally formed with the at least one tooth 210 such that each segment 202 is a unitary component. In the exemplary embodiment, each seal segment 202 is formed from a rub-tolerant material. As a result, in the event that rotor blade tip 141 contacts seal segment 202, seal segments 202 will deform to facilitate reducing and/or preventing any damage to rotor blades 146.

In the exemplary embodiment, each seal segment 202 is removably coupled to outer portion 156 such that each segment 202 extends between rotor blade tip 141 and carrier top half 150. Accordingly, in the exemplary embodiment, at least one tooth 210 is positioned adjacent to rotor blade tip 141 to facilitate sealing gap 149. More specifically, in the exemplary embodiment, seal ring assembly 200 is a retro-fit upgrade for steam turbines 100 that do not include rotor tip seal assemblies. Alternatively, seal ring assembly 200 may be installed in newly fabricated steam turbines 100. Removably coupling each seal segment 202 to outer portion 156 substantially eliminates the need to replace the entire bling assembly 152, thereby sealing gap 149 in a more cost effective manner. Accordingly, an amount of time that steam turbine 100 is offline is facilitated to be reduced. Moreover, removably coupling seal ring assembly 200 to bling assemblies 152 of each stage facilitates reducing the costs associated with sealing gap 149 as compared to other steam turbines that must replace the entire bling assembly 152 with an integral sealing extension extending therefrom.

Each seal segment 202, in the exemplary embodiment, is coupled to the existing outer portion 156 using at least one fastener 212. Alternatively, each seal segment 202 may be removably coupled to outer portion 156 using any means that enables seal segment 202 to function as described herein. In the exemplary embodiment, at least one fastener 212 extends away from each seal segment 202 and couples to outer portion 156. More specifically, each fastener 212 is substantially centered within each seal segment 202. Each seal segment 202 is circumferentially-spaced a distance away from each adjacent seal segment 202 such that a circumferential gap 214 is defined between each pair circumferentially-adjacent seal segments 202. Each circumferential gap 214 enables each seal segment 202 to thermally expand and contract with respect to at least one adjacent seal segment 202, outer portion 156, and/or the center portion of body 208, as described in more detail below.

During operation, steam is channeled through section 102, and more specifically, along steam path 148. Moreover, steam is channeled towards rotor blades 146 through inlet nozzle 136 and nozzles 158. Seal ring assembly 200, and more specifically, tooth 210 facilitates reducing an amount of steam that may flow past rotor blades 146 and through gap 149. More specifically, seal ring assembly 200 facilitates mitigating steam flow losses by substantially sealing gap 149. As a result, the amount of steam that may flow over rotor blades 146 is substantially reduced, which in turn increases the efficiency of steam turbine 100.

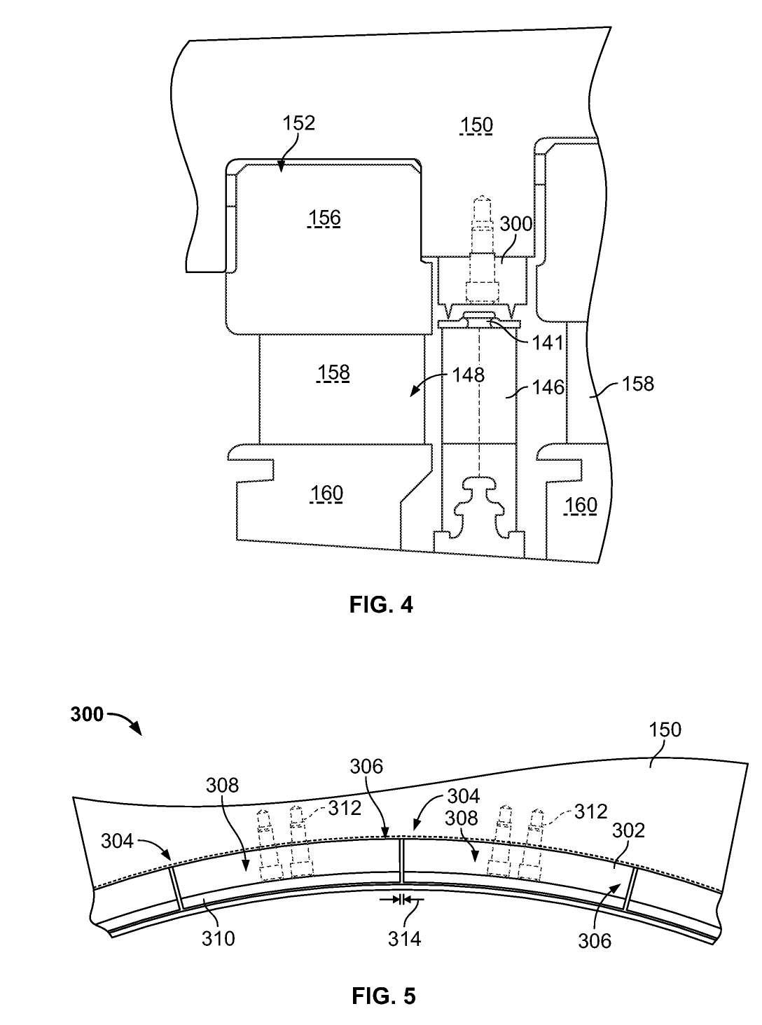

FIG. 4 is a cross-sectional view of HP section 102 of steam turbine 100 including an alternative seal ring assembly 300. FIG. 5 is an enlarged view of a portion of seal ring assembly 300. Components of seal ring assembly 300 that are substantially similar to components of seal ring assembly 200, and like components are identified with like reference numbers. In the exemplary embodiment, seal ring assembly 300 is removably coupled to the radially outer portion 156 of each bling assembly 152 in each turbine stage 147. In the exemplary embodiment, seal ring assembly 300 is substantially circular and is formed from a plurality of circumferentially-adjacent seal segments 302. Each seal segment 302 includes a first end 304, a second end 306, and a body 308 extending therebetween. Moreover, at least one tooth 310 extends radially inward from seal segment 302. Specifically, in the exemplary embodiment, each segment 302 is integrally formed with at least one tooth 310 such that each segment 302 is a unitary component. Moreover, in the exemplary embodiment, each seal segment 302 is formed from a substantially rub-tolerant material. As a result, in the event that rotor blade tip 141 contacts seal segment 302, seal segments 302 deform to facilitate preventing damage to rotor blade 146.

In the exemplary embodiment, each seal segment 302 is removably coupled to top half 150 such that each segment 302 extends between rotor blade tip 141 and carrier top half 150 and such that tooth 310 is positioned adjacent rotor blade tip 141 to facilitate sealing gap 149. Specifically, in the exemplary embodiment, seal ring assembly 300 is a retro-fit upgrade for steam turbines 100 that do not include rotor tip seal assemblies. Alternatively, seal ring assembly 300 may be installed in newly fabricated steam turbines 100. Removably coupling each seal segment 302 to top half 150 facilitates substantially eliminating the need to replace the entire bling assembly 152, which facilitates more efficient sealing of gap 149. In addition, because the entire bling assembly is not replaced, the amount of time steam turbine 100 is offline is substantially reduced. Moreover, removably coupling seal ring assembly 300 to bling assemblies 152 of each stage facilitates reducing the costs associated with sealing gap 149 as compared to steam turbines that must replace the entire bling assembly 152 with an integral sealing extension extending therefrom.

Each seal segment 302, in the exemplary embodiment, is coupled to top half 150 using at least one bolt 312. Alternatively, each seal segment 302 may be removably coupled to top half 150 using any means that enable seal segment 302 to function as described herein. In the exemplary embodiment, at least one bolt 312 extends away from each seal segment 302 to facilitate coupling segment 302. More specifically, each bolt 312 is substantially centered within each seal segment 302, and each seal segment 302 is circumferentially-spaced a distance away from each adjacent seal segment 302 such that a circumferential gap 314 is defined between each pair of circumferentially-adjacent seal segments 302. Circumferential gap 314 enables each seal segment 302 to thermally expand and contract with respect to at least one of adjacent seal segments 302, top half 150, and/or the center portion of body 308, as described in more detail below.

In the exemplary embodiment, seal ring assembly 300 is installed in steam turbine 100 as a retro-fit upgrade. Alternatively, seal ring assembly 300 may be installed on a newly manufactured steam turbine 100. A method of assembling a steam turbine with a retro-fit sealing assembly includes providing a retro-fit seal ring assembly 300. The method also includes extending at least one fastener 312 through body 308 of each seal segment 302. The method further includes coupling each seal segment 302 to an outer surface of a stationary component using the at least one fastener 312.

During operation, steam is channeled through section 102, and more specifically, along steam path 148. Moreover, steam is channeled towards rotor blades 146 through inlet nozzle 136 and nozzles 158. Seal ring assembly 300, and more specifically, tooth 310 facilitates reducing an amount of steam that may flow past rotor blades 146 and through gap 149. More specifically, seal ring assembly 300 facilitates mitigating steam flow losses by substantially sealing gap 149. As a result, the amount of steam that may flow over rotor blades 146 is substantially reduced, which in turn increases the efficiency of steam turbine 100.

In one embodiment, a method is provided for assembling a turbine engine. The method includes providing a retro-fit seal ring assembly that includes a plurality of unitary, arcuate ring segments that are circumferentially-spaced about a center axis of the ring assembly. Each of the plurality of ring segments includes a body and at least one integrally formed tooth that extends radially inward therefrom. The methods also includes extending at least one fastener through the body of each of the plurality of ring segments, and removably coupling each of the plurality of ring segments to an outer surface of a stationary component within the turbine engine using the at least one fastener.

In one embodiment, a first ring segment and a circumferentially-adjacent second ring segment are coupled to the outer surface of the stationary component such that a gap is defined therebetween to facilitate thermal expansion of the first ring segment with respect to the second ring segment. Further, in one embodiment, the at least one fastener is extended at an oblique angle to and/or parallel to the center axis of the ring segment. In the exemplary embodiment, the fastener is extended through a center portion of each ring segment. Moreover, in one embodiment, the plurality of ring segments each include a rub-tolerant material.

Exemplary embodiments of seal ring assemblies are described in detail above. The seal ring assemblies are not limited to use with the steam turbine described herein, but rather, the seal ring assemblies can be utilized independently and separately from other steam turbine components described herein. Moreover, the invention is not limited to the embodiments of the seal ring assemblies described above in detail. Rather, other variations of the seal ring assemblies may be utilized within the spirit and scope of the claims.

The above-described systems and method facilitate reducing an amount of steam that may flow past rotor blades and through a gap of a steam turbine. More specifically, the above-described systems and method facilitate mitigating steam flow losses by substantially sealing the gap. As a result, an amount of steam that may flow over the rotor blades is substantially reduced, which in turn increases the efficiency of the steam turbine. Accordingly, costs and/or time associated with maintaining and/or repairing the steam turbine are facilitated to be reduced.

While the invention has been described in terms of various specific embodiments, those skilled in the art will recognize that the invention can be practiced with modification within the spirit and scope of the claims.

What is claimed is:

1. A method of assembling a turbine engine, said method comprising:
providing a retro-fit seal ring assembly that includes a plurality of unitary, arcuate ring segments that are circumferentially-spaced about a center axis of the ring assembly, each of the plurality of ring segments includes a body and at least one integrally formed tooth that extends radially inward therefrom;
extending at least one fastener through the body of each of the plurality of ring segments; and
removably coupling each of the plurality of ring segments to an outer surface of a stationary component within the turbine engine using the at least one fastener.

2. A method of assembling a turbine engine in accordance with claim 1, wherein removably coupling each of the plurality of ring segments to an outer surface further comprises coupling a first ring segment and a circumferentially-adjacent second ring segment to the stationary component such that a pre-determined gap is defined between the first and second ring segments.

3. A method of assembling a turbine engine in accordance with claim 2, wherein coupling a first ring segment further comprises coupling the second ring segment to the stationary component such that the pre-determined gap enables thermal expansion of the first ring segment with respect to the second ring segment.

4. A method of assembling a turbine engine in accordance with claim 1, wherein extending at least one fastener through the body of each of the plurality of ring segments further comprises extending at least one fastener obliquely through each ring segment.

5. A method of assembling a turbine engine in accordance with claim 1, wherein extending at least one fastener through the body of each of the plurality of ring segments further comprises extending at least one fastener through the ring segment such that the fastener is substantially parallel to a center axis of the ring segment.

6. A method of assembling a turbine engine in accordance with claim 1, wherein extending at least one fastener through the body of each of the plurality of ring segments further comprises extending at least one fastener through a center portion of each ring segment.

7. A method of assembling a turbine engine in accordance with claim 1, wherein providing a retro-fit seal ring assembly further comprises providing a plurality of ring segments that each include a rub-tolerant material.

8. A seal ring assembly for use in a turbine engine, said assembly comprising:
a plurality of unitary, arcuate ring segments that are circumferentially-spaced about a center axis of said assembly, each of said plurality of ring segments comprises a body and at least one integrally formed tooth extending radially inward therefrom; and
at least one fastener extending through said body of each of said plurality of arcuately-shaped ring segments, each of said plurality of ring segments is removably coupled to an outer surface of a stationary component within the turbine engine using said at least one fastener.

9. A seal ring assembly in accordance with claim 8, wherein a first arcuately-shaped ring segment and a circumferentially-adjacent second arcuately-shaped ring segment are removably coupled to the outer surface of the stationary component such that a gap is defined therebetween.

10. A seal ring assembly in accordance with claim 9, wherein said gap facilitates thermal expansion of said first ring segment with respect to said second ring segment.

11. A seal ring assembly in accordance with claim 8, wherein said at least one fastener extends obliquely through said ring segment.

12. A seal ring assembly in accordance with claim 8, wherein said at least one fastener extends through said segment such that said fastener is substantially parallel to a center axis of said ring segment.

13. A seal ring assembly in accordance with claim 8, wherein said at least one fastener extends through a center portion of each of said ring segment.

14. A seal ring assembly in accordance with claim 8, wherein each of said plurality of ring segments comprises a rub-tolerant material.

15. A turbine engine comprising:
a stationary component; and
a seal ring assembly coupled to the stationary component, said ring assembly comprising:
a plurality of unitary, arcuate ring segments that are circumferentially-spaced about a center axis of said assembly, each of said plurality of ring segments comprises a body and at least one integrally formed tooth extending radially inward therefrom; and
at least one fastener extending through said body of each of said plurality of arcuately-shaped ring segments, each of said plurality of ring segments is removably coupled to an outer surface of a stationary component within the turbine engine using said at least one fastener.

16. A turbine engine in accordance with claim 15, wherein a first arcuately-shaped ring segment and a circumferentially-adjacent second arcuately-shaped ring segment are removably coupled to the outer surface of the stationary component such that a gap is defined therebetween.

17. A turbine engine in accordance with claim 15, wherein said gap facilitates thermal expansion of said first ring segment with respect to said second ring segment.

18. A turbine engine in accordance with claim 15, wherein said at least one fastener extends at least one of obliquely through said ring segment and substantially parallel to a center axis of said ring segment.

19. A turbine engine in accordance with claim 15, wherein said at least one fastener extends through a center portion of each of said ring segment.

20. A turbine engine in accordance with claim 15, wherein each of said plurality of ring segments comprises a rub-tolerant material.
